(19) United States
(12) Patent Application Publication
(10) Pub. No.: US 2008/0018313 A1
(43) Pub. Date: Jan. 24, 2008

(54) POWER SUPPLY SYSTEM USING DELAY LINES IN REGULATOR TOPOLOGY TO REDUCE INPUT RIPPLE VOLTAGE

(75) Inventors: Brian J. Cagno, Tucson, AZ (US); John C. Elliott, Tucson, AZ (US); Enrique Q. Garcia, Tucson, AZ (US)

Correspondence Address: CANTOR COLBURN LLP - IBM TUSCON DIVISION, 55 GRIFFIN ROAD SOUTH, BLOOMFIELD, CT, 06002, US

(73) Assignee: International Business Machines Corporation, Armonk, NY (US)

(21) Appl. No.: 11/458,750

(22) Filed: Jul. 20, 2006

(51) Int. Cl. G05F 1/00

(52) U.S. Cl. 323/282

(57) ABSTRACT

A power supply system for reducing input ripple voltage, the system including: a first switching regulator having at least two input pins, one input pin being a voltage input pin and another input pin being a synchronization input pin; a second switching regulator having at least two input pins, one input pin being a voltage input pin and another input pin being a synchronization input pin; wherein outputs of the first switching regulator and the second switching regulator are connected to a power bus; a first delay element connected to the synchronization input pin of the first switching regulator; a second delay element connected to the synchronization input pin of the second switching regulator; wherein the first delay element and the second delay element have different delays, the first switching regulator and second switching regulator operating out of phase; and a master clock for providing timing control to the first and second delay elements.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a switching regulator, and particularly to a method of adding a delay line to the synchronization input of the switching regulator to reduce the input ripple voltage.

2. Description of Background

It is well known in the switching regulator art that operation at higher frequencies leads to smaller size, weight, etc. To achieve high frequency with its associated high power and current, it is necessary to make the physical packaging of the transformer and rectifiers as small as possible due to current switching in the transformer windings and rectifiers. In such designs, voltages must be limited to values below the breakdown rating of the switches and rectifiers, and finite inductances are inevitable.

Given the low voltage, high current and finite inductance requirements, switching or commutation of current requires time. The commutation time increases in direct proportion to the magnitude of the current and, in practical designs, is limited to a small percentage of the overall cycle time. Thus, the maximum operating frequency of current switching regulators is limited by the current, voltage and inductance parameters in the circuit.

In particular, as electrical designs become more complex the need for multiple DC to DC voltage regulators on a single card increases. Current designs using several large ASICs (Application-Specific Integrated Circuit) can contain over twenty separate regulators. The most common type of regulator is a switching regulator due to its high efficiency. The basic problem with these regulators, however, is that they create voltage ripple on the main input voltage due to topology of the regulator. This voltage ripple is additive for each regulator such that twenty regulators could have twenty times the voltage ripple on the input voltage. The best current method for reducing the input ripple is to add capacitance to the circuit topology. However, this has significant physical and space limitations. At such high switching frequencies (high switching frequencies are used to reduce capacitor size) layout becomes extremely important and it is not physically possible to place the capacitors close enough to the regulator to combat the noise.

Thus, it is well known that switching regulators create high voltage ripple on the main input voltage. Current methods for reducing the voltage ripple include adding capacitance to the circuit topology. However, adding capacitance has significant physical and space limitations. Therefore, it is desired to reduce input ripple voltage by a method not including additional capacitance within a circuit topology including a plurality of switching regulators.

### SUMMARY OF THE INVENTION

The shortcomings of the prior art are overcome and additional advantages are provided through the provision of a power supply system for reducing input ripple voltage, the system comprising: a first switching regulator having at least two input pins, one input pin being a voltage input pin and another input pin being a synchronization input pin; a second switching regulator having at least two input pins, one input pin being a voltage input pin and another input pin being a synchronization input pin; wherein outputs of the first switching regulator and the second switching regulator are connected to a power bus; a first delay element connected to the synchronization input pin of the first switching regulator; a second delay element connected to the synchronization input pin of the second switching regulator; wherein the first delay element and the second delay element have different delays, the first switching regulator and second switching regulator operating out of phase; and a master clock for providing timing control to the first and second delay elements.

Additional features and advantages are realized through the techniques of the present invention. Other embodiments and aspects of the invention are described in detail herein and are considered a part of the claimed invention. For a better understanding of the invention with advantages and features, refer to the description and the drawings.

### Technical Effects

As a result of the summarized invention, technically we have achieved a solution that reduces input ripple voltage by adding a delay line to a synchronization input pin of a switching regulator.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a graph showing the input ripple voltage of a set of switching regulators without a delay line at the synchronization input;

FIG. 2 illustrates one example of a graph showing the input ripple voltage of a set of switching regulators with a delay line at the synchronization input;

FIG. 3 illustrates one example of a switching regulator circuit without a delay element at the synchronization input; and

FIG. 4 illustrates one example of a switching regulator circuit with a delay element at the synchronization input; and

FIG. 5 illustrates one example of a power supply system including multiple switching regulators connected to a bus.

### DETAILED DESCRIPTION OF THE INVENTION

One aspect of the exemplary embodiments is a method for reducing voltage ripple in switching regulators. Another aspect of the exemplary embodiments is a method for reducing input voltage ripple in switching regulators by adding a delay line to the synchronization input pin of one or more switching regulators.

There are two types of regulators, one is a linear regulator and the other is a switching regulator. Switching regulators are more efficient than linear regulators because switching regulators transform power while linear regulators consume power to regulate. Also, switching regulators store-up energy in a magnetic field and recover the energy when the magnetic field collapses. They also radiate considerable EMI (Electro-Magnetic Interference) as a result of inductor high current switching. Finally, switching regulators are usually used in applications involving high power and where efficiency is of primary concern.

The switching regulator is nothing more than just a simple switch. This switch goes on and off at a fixed rate set by the circuit. The time that the switch remains closed during each switch cycle is varied to maintain a constant output voltage. The primary filter capacitor is on the output of the switching regulator and not on the input side, as is common in linear regulators. The switching regulator is much more efficient than the linear regulator achieving efficiencies as high as 80% to 95% in some circuits. The obvious result is smaller heat sinks, less heat generation, and smaller overall size of power supplies.

Moreover, because of the unique nature of switching regulators, very special design considerations are required. Because the switching system operates in the 50 kHz to 1 MHz region, with frequencies increasing to decrease design space required, and has an almost square waveform, it is rich in harmonics way up into the High Frequency (HF) and even the VHF/UHF (Very High Frequency/Ultra High Frequency) region. Special filtering is required, along with shielding, minimized lead lengths and various filters on leads exiting the switching regulator. The switching regulator also has a minimum load requirement, which is determined by the inductor value. Without the minimum load, the regulator generates excessive noise and harmonics and could even damage itself. To meet this requirement, many designers use a cooling fan and or a minimum load, which switches out when no longer needed.

Switching voltage regulators are commonly used for both step-up and step-down applications, and differ from linear regulators by means of pulse-width modulation (PWM) implementation. Switching regulators control the output voltage by using a current switch (internal or external to the IC (Integrated Circuit) regulator) with a constant frequency and variable duty-cycle. Switching frequencies are generally from a few kHz to a few MHz. The switch duty-cycle ratio determines how much and how quickly the output supply voltage increases or decreases, depending on the load state and input source voltage. Some switching regulators utilize both variable switching frequency and duty-cycle to increase efficiency at various loads.

The advantage of switching regulators is efficiency, as minimal power is dissipated in the power path (Field-Effect Transistors (FET) switches) when the output supply voltage is sufficient for the load state. Essentially, the power converter “shuts off” when power is not needed, due to minimal switch duty-cycle. The disadvantage of switching regulators is complexity, as several external passive components are required on board, as well as high input voltage ripple. In the case of high-current applications, external FET ICs are required as the IC-converter acts only as control logic for the external FET switch. Output voltage ripple is generally handled with bypass capacitance near the supply and at the load.

Capacitor parasitics significantly affect switching regulator performance. All capacitors contain parasitic elements, which make their performance less than ideal. Some of these parasitic elements include an Equivalent Series Resistance (ESR) and an Effective Series Inductance (ESL). In particular, the ESR causes internal heating due to power dissipation as the ripple current flows into and out of the capacitor. The capacitor can fail if ripple current exceeds maximum ratings. Excessive output voltage ripple will result from high ESR, and regulator loop instability is also possible. ESR is highly dependent on temperature, increasing very quickly at temperatures below about 10° C. On the other hand, the ESL limits the high frequency effectiveness of the capacitor. High ESL is the reason electrolytic capacitors need to be bypassed by film or ceramic capacitors to provide good high-frequency performance. The ESR and ESL within the capacitor form a resonant circuit, whose frequency of resonance should be as high as possible. Switching regulators generate ripple voltages on their outputs with very high frequency (>10 MHz) components, which can cause ringing on the output voltage if the capacitor resonant frequency is low enough to be near these frequencies. Also, significant input ripple voltages are generated.

Furthermore, concerning the output capacitor ESR effects, the primary function of the output capacitor in a switching regulator is filtering. As the converter operates, current flows into and out of the output filter capacitor. The ESR of the output capacitor directly affects the performance of the switching regulator. The manufacturer of high quality capacitors specifies ESR. However, it is required to be specified at the frequency of intended operation. General-purpose electrolytics usually only specify ESR at 120 Hz, but capacitors intended for high-frequency switching applications will have the ESR guaranteed at high frequency (like 20 kHz to 100 kHz).

Some of the ESR dependent parameters are: (1) Ripple Voltage, (2) Efficiency, and (3) Loop Stability. Concerning ripple voltage, in most cases, the majority of the input and output ripple voltage results from the ESR of the output capacitor. If the ESR increases (as it will at low operating temperatures) the input and output ripple voltage will increase accordingly. Concerning efficiency, as the switching current flows into and out of the capacitor (through the ESR), power is dissipated internally. This “wasted” power reduces overall regulator efficiency, and can also cause the capacitor to fail if the ripple current exceeds the maximum allowable specification for the capacitor. Concerning loop stability, the ESR of the output capacitor can affect regulator loop stability.

The input and output ripple voltage can be measured via an oscilloscope. In particular, the ripple appearing on the output of the switching regulator can be important to the circuits under power. However, obtaining an accurate measurement of the output ripple voltage is not always simple. If the output voltage waveform is measured using an oscilloscope, an accurate result can only be obtained using a differential measurement method, as is the case in the exemplary embodiments of the present application.

The exemplary embodiments of the present application pertain to a method for reducing input ripple voltage. This method pertains to certain switching regulators that provide a synchronization (sync) input. This input is intended to be used to synchronize the switching of a limited number of regulators in order to make the system more predictable. The exemplary embodiments provide for a delay line being added to the sync pin. The addition of the sync pin runs the regulators out of phase so that the input ripple voltage does not become additive, instead it is averaged out over a clock cycle. By using these readily available and inexpensive delay lines, the input capacitors and layout is not as critical since the input ripple is no longer additive.

In particular, switching regulators can be thought of as two light switches, one connected to power and the other to a ground reference. By alternating the light switches on and off in the appropriate sequence and timing, most any output voltage can be created from the input. For instance, if each light switch is on half the time, the output is half the amplitude. The issue is that every time the high side light switch is turned on, a current surge is applied to the input, which creates a momentary voltage dip. If a user turns on twenty light switches all at once, it causes a current surge twenty times larger than one switch turning on. But, if the twenty light switches are staggered, the current surge is averaged out over time. The same principle of the light switch example applies to switching regulators. By using a master clock with delay line taps feeding sync lines to different regulators the input current surge (which shows up as voltage noise) is averaged out.

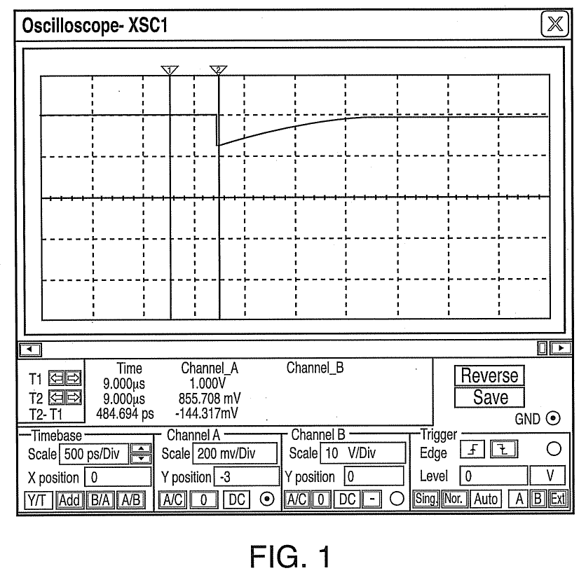

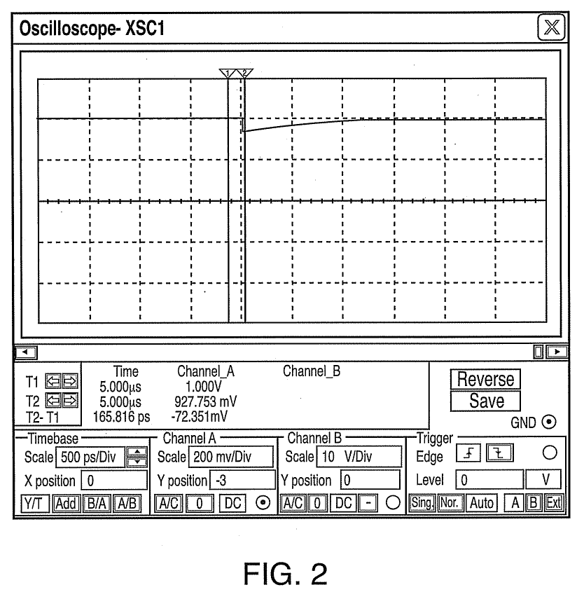

Referring to FIGS. 1 and 2, two screen shots are provided of simulations of a switching regulator model. The screen shots are simulations of a two-regulator topology (although topology can be extended well beyond two), in which the switching is synchronized. FIG. 1 illustrates one example of a graph showing the ripple voltage of a switching regulator without a delay line at the synchronization input. The input voltage ripple in FIG. 1 was measured to be 144 mV. FIG. 2 illustrates one example of a graph showing the ripple voltage of the same switching regulators but with a delay line at the synchronization input. In FIG. 2, the simulation was run with a 500 nS delay on one of the sync pins on the regulator model. That simulation shows only a 72 mV ripple voltage on the input. Therefore, by adding a delay line to the input synchronization pin of one or more voltage regulators within a circuit, the input voltage ripple dropped by 50%. This result is even more significant when a plurality of voltage regulators are added within a circuit. In particular, extending this basic model out to a twenty-regulator design, the voltage ripple could be as high as 1.44 volts. Depending on the number of regulators and their switching frequency it's possible to get over a 20 times reduction on input voltage ripple.

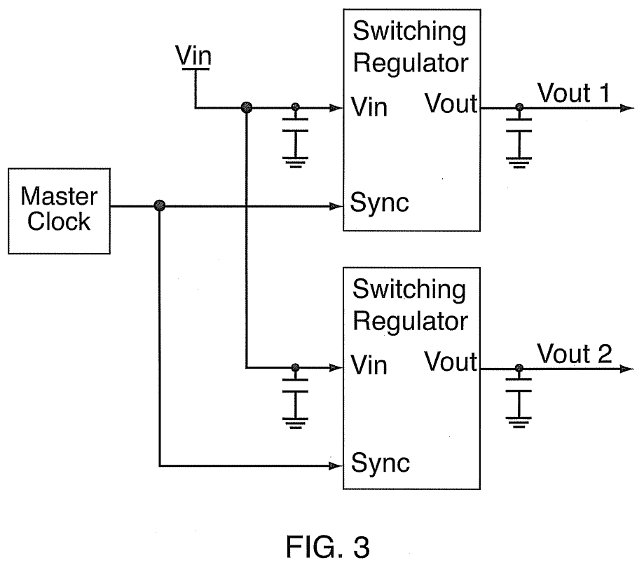

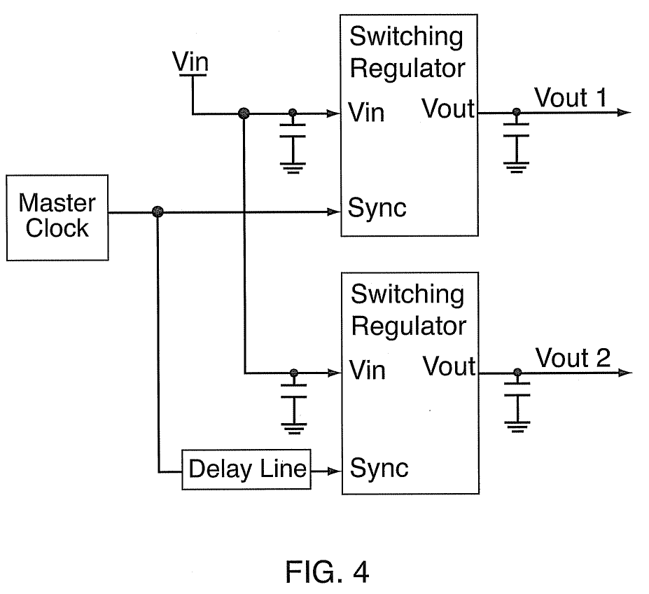

FIGS. 3 and 4 illustrate one example of a switching regulator circuit without a delay element at the synchronization input, and one example of a switching regulator circuit with a delay element at the synchronization input, respectively. FIGS. 3 and 4 are the circuits that were built and connected to an oscilloscope to obtain the oscilloscope readings of FIGS. 1 and 2, respectively.

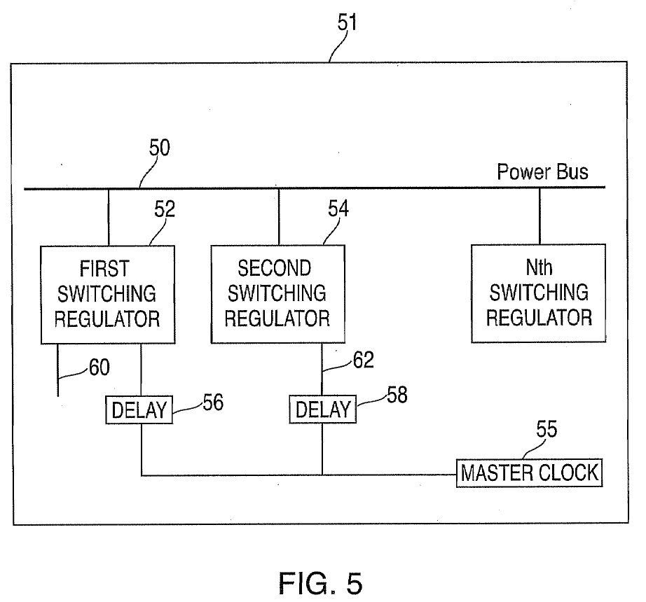

Referring to FIG. 5, a power supply system 51 is provided. The power supply system 51 includes a power bus 50, a first switching regulator 52, a second switching regulator 54, a master clock 55, delay elements 56 and 58, a voltage input pin 60, and a synchronization pin 62. The first switching regulator 52 and the second switching regulator 54 are connected to the power bus 50. Delay element 56 is connected to a pin of the first switching regulator 52 and delay element 58 is connected to the synchronization pin 62 of the second switching regulator 54. Each of the delay elements 56 and 58 are connected to the master clock 55. Moreover, the first switching regulator 52 and the second switching regulator 54 each include a delay element at synchronization input pins so as to run out of phase. This method of input voltage ripple reduction can be expanded to support large numbers of regulators by simply adding different delays to the synchronization input to each regulator.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A power supply system for reducing input ripple voltage, the system comprising:
a first switching regulator having at least two input pins, one input pin being a voltage input pin and another input pin being a synchronization input pin;
a second switching regulator having at least two input pins, one input pin being a voltage input pin and another input pin being a synchronization input pin;
wherein outputs of the first switching regulator and the second switching regulator are connected to a power bus;
a first delay element connected to the synchronization input pin of the first switching regulator;
a second delay element connected to the synchronization input pin of the second switching regulator;
wherein the first delay element and the second delay element have different delays, the first switching regulator and second switching regulator operating out of phase; and
a master clock for providing timing control to the first and second delay elements.

2. The system of claim 1, wherein the first delay element is a 500 ns delay.

3. The system of claim 1, wherein the second delay element is a 500 ns delay.
